(19) United States
(12) Patent Application Publication
(10) Pub. No.: US 2004/0077247 A1
(43) Pub. Date: Apr. 22, 2004

(54) Lofty spunbond nonwoven laminate

(76) Inventors: Richard J. Schmidt, Roswell, GA (US); Eric Scott Kepner, Alpharetta, GA (US); Christopher Dale Fenwick, Alpharetta, GA (US); Chad Michael Freese, Davis, CA (US)

Correspondence Address: KIMBERLY-CLARK WORLDWIDE, INC., 401 NORTH LAKE STREET, NEENAH, WI, 54956

(21) Appl. No.: 10/277,488

(22) Filed: Oct. 22, 2002

(51) Int. Cl. B32B 5/26; D04H 3/00

(52) U.S. Cl. 442/382; 442/327; 442/346; 442/361; 442/362; 442/381

(57) ABSTRACT

The present invention is a laminate of a low loft layer, the first layer, and a high loft layer, the second layer. More specifically, the present invention provides a nonwoven laminate containing a first layer from thermoplastic spunbond filaments having an average denier less than about 1.8 dpf (2.0 dtex); and a second layer containing thermoplastic multicomponent spunbond filaments having an average denier greater than about 2.3 dpf (2.55 dtex). The laminate has a structure such that the density of the first layer is greater than the density of the second layer and the thickness of the second layer is greater than the thickness of the first layer. Also disclosed is a laminate containing the laminate of a low loft layer containing spunbond filaments having an average denier less than 1.8 dpf (2.0 dtex), a high loft layer containing thermoplastic multicomponent spunbond filaments having an average denier greater than about 2.3 dpf (2.55 dtex) and layer containing a meltblown nonwoven web. The meltblown layer may be between the high loft layer and the low loft layer, adjacent to the high loft layer and opposite the low loft layer, adjacent to the low loft layer and opposite the high loft layer. Additionally, the present invention relates to a thermal or acoustical insulation material which contains the laminate of the high loft layer and the low loft layer, or the laminate of the low loft layer, the high loft layer and a meltblown nonwoven web. Also disclosed is a method of attenuating sound waves passing from a sound source area to a second area. The method includes positioning an acoustical insulation material containing the nonwoven laminate of the present invention between the sound source area and the second area.

### FIELD OF THE INVENTION

The present invention relates to a nonwoven web laminate having a relatively high density, low loft layer and a relatively low density, high loft layer. More specifically, the present invention relates to a thermal or acoustical insulation material prepared from the nonwoven web laminate which can be used as insulation in vehicles, appliances, architectural applications and other locations where thermal insulation or sound attenuation is desired or required.

### BACKGROUND OF THE INVENTION

Nonwoven webs are used to make a variety of products, which desirably have particular levels of softness, strength, uniformity, liquid handling properties such as absorbency, and other physical properties. Such products include towels, industrial wipes, incontinence products, infant care products such as baby diapers, absorbent feminine care products, and garments such as medical apparel. These products are often made with multiple layers of nonwoven fabric to obtain the desired combination of properties. For example, disposable baby diapers made from polymeric nonwoven fabrics may include a liner layer which fits next to the baby's skin and is soft, strong and porous, a liquid impervious outer cover layer which is strong and soft, and one or more interior liquid handling layers which are soft, bulky and absorbent. Other uses of bulky or lofty nonwoven webs include filter materials and sound absorbing materials.

Many different sound insulation materials are available in the art. These materials have been used in a variety of applications, for example, to reduce noise from appliances, within buildings, from HVAC systems, within vehicles and the like. The selection of a particular sound insulation material is governed by several factors, including cost, thickness, weight and the ability to attenuate sound. Sound insulation attenuates sound by either absorbing sound waves striking the insulation or reflecting such sound waves outwardly and away from a receiving area. Sound attenuation is measured by the ability of a material to absorb incident sound waves (sound absorption) and/or by the ability of the material to reflect incident sound waves. Ideally, a sound attenuation material has a high sound absorption coefficient and/or a high transmission loss value.

Conventional sound insulating materials include materials such as foams, compressed fibers, fiberglass batts, felts and nonwoven webs of fibers. Of the nonwoven webs of fibers, meltblown fibers have been widely used in sound insulation materials. In addition, laminates of meltblown nonwoven webs have been used as acoustical insulation. In these prior uses of meltblown nonwoven webs in acoustical insulation, the meltblown nonwoven web typically was a relatively thick, low density layer of meltblown fibers, usually having a thickness of at least 5 mm and a density less than 50 kg/m³.

Examples of such meltblown containing acoustical insulation are described in U.S. Pat. Nos. Re 36,323 to Thompson et al.; U.S. Pat. No. 5,773,375 to Thompson et al.; U.S. Pat. No. 5,841,081 to Thompson et al. These patents teach laminates containing meltblown fibers; however, the laminates have the problem of dimensional stability, meaning that the laminate does not retain its shape during handling, including compaction of the fibers and tearing or breaking of parts molded out of this material.

Another acoustical insulation containing meltblown fibers is described in U.S. Pat. No. 6,217,691 to Vair et al. In this patent, a mat of meltblown fibrous insulation is produced from meltblown fibers having a mean fiber diameter of less than 13 microns, a density less than about 60 kg/m³, preferably less than about 50 kg/m³, and a thickness between 3 and 20 mm. In the production of the acoustical insulation in this patent, the fibers located on at least one of the top and bottom surfaces of the meltblown are melted to form a thin integral skin. The resulting material is then point bonded to provide integrity to the mat. In addition, the integral skin layer is perforated to provide air permeability to the mat.

In U.S. Pat. No. 3,773,605 to Pihlstrom, an acoustical insulation material is produced by fusing and integrating several layers of a meltblown nonwoven web to form a panel having a density between 0.01 and about 0.3 g/cc. The resulting nonwoven web has a thickness greater than about 7 mm.

There is a need in the art for an acoustical insulation material which can be used in place of conventional acoustical insulation materials, such as fiberglass and the like, which avoids the known problems associated with these materials, such as loss of the fibers during installation.

### SUMMARY OF THE INVENTION

The present invention is a laminate including a low loft layer, the first layer, and a high loft layer, the second layer. More specifically, the present invention provides a nonwoven laminate containing a first layer from thermoplastic spunbond filaments having an average denier less than about 1.8 dpf (2.0 dtex); and a second layer containing thermoplastic multicomponent spunbond filaments having an average denier greater than about 2.3 dpf (2.55 dtex). The laminate has a structure such that the density of the first layer is greater than the density of the second layer and the thickness of the second layer is greater than the thickness of the first layer.

This invention also relates to a laminate containing the laminate of a low loft layer containing spunbond filaments having an average denier less than 1.8 dpf (2.0 dtex), a high loft layer containing thermoplastic multicomponent spunbond filaments having an average denier greater than about 2.3 dpf (2.55 dtex) and layer containing a meltblown nonwoven web. The meltblown layer may be between the high loft layer and the low loft layer, adjacent to the high loft layer and opposite the low loft layer, adjacent to the low loft layer and opposite the high loft layer.

Additionally, the present invention relates to a thermal or acoustical insulation material which contains the laminate of the high loft layer and the low loft layer, or the laminate of the low loft layer, the high loft layer and a meltblown nonwoven web. The laminate of the present invention can also be used in building materials, such as, floor underlayment, wall panels and ceiling tiles.

The present invention also relates to a method of attenuating sound waves passing from a sound source area to a second area. The method includes positioning an acoustical insulation material containing the nonwoven laminate of the present invention between the sound source area and the second area.

### BRIEF DESCRIPTION OF THE DRAWINGS

FIGS. 1A, 1B, 1C and 1D show different structures of the laminate of the present invention.

FIG. 2 shows a schematic diagram of the process of producing the high loft material and low loft material of the present invention.

FIG. 3 shows a schematic diagram of another process of producing the laminate of the high loft material and the low loft material.

FIG. 4 shows the absorption coefficient curves for the high loft/low loft laminate of the present invention.

FIG. 5 shows the absorption coefficient curves for the high loft/low loft/meltblown laminate of the present invention.

### DEFINITIONS

As used herein, the term “comprising” is inclusive or open-ended and does not exclude additional unrecited elements, compositional components, or method steps.

As used herein, the term “fiber” includes both staple fibers, i.e., fibers which have a defined length between about 19 mm and about 60 mm, fibers longer than staple fiber but are not continuous, and continuous fibers, which are sometimes called “substantially continuous filaments” or simply “filaments”. The method in which the fiber is prepared will determine if the fiber is a staple fiber or a continuous filament.

As used herein, the term “nonwoven web” means a web having a structure of individual fibers or threads which are interlaid, but not in an identifiable manner as in a knitted web. Nonwoven webs have been formed from many processes, such as, for example, meltblowing processes, spunbonding processes, air-laying processes, coforming processes and bonded carded web processes. The basis weight of nonwoven webs is usually expressed in ounces of material per square yard (osy) or grams per square meter (gsm) and the fiber diameters useful are usually expressed in microns, or in the case of staple fibers, denier. It is noted that to convert from osy to gsm, multiply osy by 33.91.

As used herein, the term “meltblown fibers” means fibers formed by extruding a molten thermoplastic material through a plurality of fine, usually circular, die capillaries as molten threads or filaments into converging high velocity, usually hot, gas (e.g. air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Butin, which is hereby incorporated by reference in its entirety. Meltblown fibers are microfibers, which may be continuous or discontinuous, and are generally smaller than 10 microns in average diameter The term “meltblown” is also intended to cover other processes in which a high velocity gas, (usually air) is used to aid in the formation of the filaments, such as melt spraying or centrifugal spinning.

As used herein the term “spunbond fibers” refers to small diameter fibers of molecularly oriented polymeric material. Spunbond fibers may be formed by extruding molten thermoplastic material as filaments from a plurality of fine, usually circular capillaries of a spinneret with the diameter of the extruded filaments then being rapidly reduced as in, for example, U.S. Pat. No. 4,340,563 to Appel et al., and U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3,502,763 to Hartman, U.S. Pat. No. 3,542,615 to Dobo et al, and U.S. Pat. No. 5,382,400 to Pike et al. Spunbond fibers are generally not tacky when they are deposited onto a collecting surface and are generally continuous. Spunbond fibers are often about 10 microns or greater in diameter. However, fine fiber spunbond webs (having an average fiber diameter less than about 10 microns) may be achieved by various methods including, but not limited to, those described in commonly assigned U.S. Pat. No. 6,200,669 to Marmon et al. and U.S. Pat. No. 5,759,926 to Pike et al., each is hereby incorporated by reference in its entirety.

As used herein, the term “polymer” generally includes, but is not limited to, homopolymers, copolymers, such as for example, block, graft, random and alternating copolymers, terpolymers, etc. and blends and modifications thereof. Furthermore, unless otherwise specifically limited, the term “polymer” shall include all possible geometrical configurations of the molecule. These configurations include, but are not limited to isotactic, syndiotactic and random symmetries.

As used herein, the term “multicomponent fibers” refers to fibers or filaments which have been formed from at least two polymers extruded from separate extruders but spun together to form one fiber. Multicomponent fibers are also sometimes referred to as “conjugate” or “bicomponent” fibers or filaments. The term “bicomponent” means that there are two polymeric components making up the fibers. The polymers are usually different from each other, although conjugate fibers may be prepared from the same polymer, if the polymer in each component is different from one another in some physical property, such as, for example, melting point or the softening point. In all cases, the polymers are arranged in substantially constantly positioned distinct zones across the cross-section of the multicomponent fibers or filaments and extend continuously along the length of the multicomponent fibers or filaments. The configuration of such a multicomponent fiber may be, for example, a sheath/core arrangement, wherein one polymer is surrounded by another, a side-by-side arrangement, a pie arrangement or an “islands-in-the-sea” arrangement. Multicomponent fibers are taught in U.S. Pat. No. 5,108,820 to Kaneko et al.; U.S. Pat. No. 5,336,552 to Strack et al.; and U.S. Pat. No. 5,382,400 to Pike et al.; the entire content of each is incorporated herein by reference. For two component fibers or filaments, the polymers may be present in ratios of 75/25, 50/50, 25/75 or any other desired ratios.

As used herein, the term “multiconstituent fibers” refers to fibers which have been formed from at least two polymers extruded from the same extruder as a blend or mixture. Multiconstituent fibers do not have the various polymer components arranged in relatively constantly positioned distinct zones across the cross-sectional area of the fiber and the various polymers are usually not continuous along the entire length of the fiber, instead usually forming fibrils or protofibrils which start and end at random. Fibers of this general type are discussed in, for example, U.S. Pat. Nos. 5,108,827 and 5,294,482 to Gessner.

As used herein, the term “pattern bonded” refers to a process of bonding a nonwoven web in a pattern by the application of heat and pressure or other methods, such as ultrasonic bonding. Thermal pattern bonding typically is carried out at a temperature in a range of from about 80° C. to about 180° C. and a pressure in a range of from about 150 to about 1,000 pounds per linear inch (59-178 kg/cm). The pattern employed typically will have from about 10 to about 250 bonds/inch² (1-40 bonds/cm²) covering from about 5 to about 30 percent of the surface area. Such pattern bonding is accomplished in accordance with known procedures. See, for example, U.S. Design Pat. No. 239,566 to Vogt, U.S. Design Pat. No. 264,512 to Rogers, U.S. Pat. No. 3,855,046 to Hansen et al., and U.S. Pat. No. 4,493,868 to Meitner et al. and U.S. Pat. No. 5,858,515 to Stokes et al., for illustrations of bonding patterns and a discussion of bonding procedures, which patents are incorporated herein by reference. Ultrasonic bonding is performed, for example, by passing the multilayer nonwoven web laminate between a sonic horn and anvil roll as illustrated in U.S. Pat. No. 4,374,888 to Bornslaeger, which is hereby incorporated by reference in its entirety.

As used herein, the phrase “high loft material” refers to a material which has a z-direction thickness generally in excess of about 3 mm and a relatively low bulk density. The thickness or bulk of the high loft material web is measured at 0.05 psi (3.5 g/cm³) with a STARRET-7 type bulk tester. Samples were cut into 4 inch by 4 inch (10.2 cm by 10.2 cm) squares and five samples were tested to determine bulk or thickness. Desirably, the thickness is greater than about 4 mm. The bulk density is calculated by dividing the basis weight of the web by the bulk. The bulk density of high loft webs is typically less than about 50 kg/m³.

As used herein, the phrase “low loft material” refers to a material which has a z-direction thickness generally less than about 3 mm and a relatively high bulk density. The thickness or bulk of the high loft material web is measured at 0.05 psi (3.5 g/cm³) with a STARRET-7 type bulk tester. Samples were cut into 4 inch by 4 inch (10.2 cm by 10.2 cm) squares and five samples were tested to determine bulk or thickness. The bulk density is calculated by dividing the basis weight of the web by the bulk. The bulk density of low loft webs is typically greater than about 20 kg/m³.

As used herein the term “denier” refers to a commonly used expression of fiber thickness which is defined as grams per 9000 meters. A lower denier indicates a finer fiber and a higher denier indicates a thicker or heavier fiber. Denier can be converted to the international measurement “dtex”, which is defined as grams per 10,000 meters, by dividing denier by 0.9.

As used herein, the phrase “sound attenuation” refers to absorption and/or reflection of incident sound waves.

### DETAILED DESCRIPTION

The present invention is a laminate of low loft material layer, the first layer, and a high loft material layer, the second layer. It has been discovered that the nonwoven laminate of the present invention is very effective as a thermal and/or sound attenuation material. More specifically, the present invention relates to a nonwoven laminate containing a first layer from thermoplastic spunbond filaments having an average denier less than about 1.8 dpf (2.0 dtex); and a second layer comprising thermoplastic multicomponent spunbond filaments having an average denier greater than about 2.3 dpf (2.55 dtex). The laminate has a structure such that the density of the first layer is greater than the density of the second layer and the thickness of the second layer is greater than the thickness of the first layer. The nonwoven laminate can be used in locations where conventional thermal and sound insulation materials, such as fiberglass have been previously used. In addition, the nonwoven laminate of the present invention can be used in place of the dimensionally unstable meltblown material mentioned in the Background of the present invention.

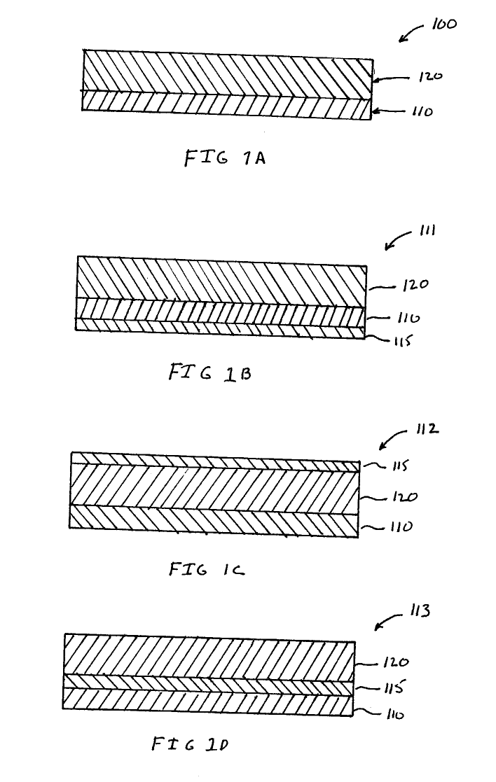

To obtain a better understanding of the laminate of this invention, attention is directed to FIG. 1A. As is shown in FIG. 1A, the nonwoven web laminate 100 has two layers, a first layer (low loft layer) 110 and a second layer (high loft layer) 120.

The first layer of the laminate of the present invention is denser than the second layer and the first layer has a thickness which is less than the second layer. The first layer is a low loft, relatively high density layer and the second layer is a high loft, relatively low density layer. The phrase “low loft layer”, as used herein, refers to the first layer and the phrase “high loft layer” refers to the second layer of the laminate material. The overall laminate material has a lofty appearance, and is generally at least about 3.0 mm thick. The overall thickness can be as thick as needed and higher thicknesses may be accomplished by laminating additional high loft layers to the laminate material. Without the additional layers laminated onto the two layer laminate, the overall thickness of the laminate can be as high as about 12.7 cm or more. Typically, the thickness of the high loft layer is in the range of about 3 mm to about 38 mm, more typically between about 6 mm and about 26 mm. Generally, the low loft layer has a thickness less than about 3 mm, desirably below 2 mm and possibly less than 1 mm. Desirably, the thickness of the low loft layer is between about 1 and 2 mm. In the present invention, the actual thickness of each layer is not critical; however, the low loft layer must be thinner than the high loft layer.

The low loft layer preferably has a density greater than about 20 kg/m³, desirably greater than about 30 kg/m³, and most desirably greater than about 40 kg/m³. The upper limit of the density of the low loft layer is not critical to the present invention; however, from a practical standpoint the upper limit for density of the low loft layer is about 250 kg/m³. The low loft layer provides the sound attenuation properties of the laminate material.

The high loft layer preferably has a density less than 50 kg/m³, desirably less than about 40 kg/m³, and most desirably less than about 20 kg/m³. From a practical standpoint, the lowest density obtainable is in the neighborhood of about 1 kg/m³. Lower densities are preferred to reduce the overall weight of the material. The low density is used to hold the material in place during use by taking up space in cavities in which the material can be used. It is noted that the density of the high loft layer overlaps the density of the low loft layer. For the present invention, the high loft layer needs to have a density less than the density of the low loft layer. For example, if the density of the high loft layer is 50 kg/m³, then the density of the low loft layer must be greater than 50 kg/m³.

In the present invention, the denier of the low loft layer must be less than 1.8 dpf (2.0 dtex). Smaller denier filaments in the low loft layer results in improved acoustical properties of the laminate. Smaller deniers allow for more filaments per volume density, which results in a more torturous path for the sound to travel through the laminate. In the present invention, the spunbond filaments of the low loft layer are preferably less than about 1.7 dpf (1.89 dtex), and more preferably less than 1.5 dpf (1.66 dtex). From a practical standpoint, the lower limit of the denier is about 0.1 dpf (0.11 dtex). If the denier is higher than about 1.8 dpf (2.0 dtex), the low loft layer may tend to crimp during further processing, such as bonding. Further, if the denier of the low loft layer is higher than about 1.8 dpf (2.0 dtex), the sound attenuating properties of the resulting laminate will be reduced.

The denier of the filaments in the high loft layer of the laminate of the present invention should be greater than 2.3 dpf (2.55 dtex). Ideally, the denier should be greater than about 3.0 dpf (3.33 dtex) and preferably greater than 4.0 dpf (4.44 dtex). If the denier is less than about 2.3 dpf (2.55 dtex), the resulting nonwoven web will not have sufficient loft. As denier for the spunbond filaments rises, the filaments are thicker, have more resilience and there are less filaments per volume density. From a practical processing standpoint, the upper limit of the denier is about 15 dpf (16.66 dtex).

Denier of filaments in a spunbonding process can be adjusted by methods known to those skilled in the art, such as adjusting the polymer through-put, the velocity (pressure) of the draw air, reducing the orifice size in the spin plate and the like. For example, denier of spunbond filaments can be reduced by reducing the polymer through-put through the spin plate or by increasing the draw air pressure. Conversely, denier of spunbond filaments can be increased by increasing the polymer through-put through the spin plate or by decreasing the draw air pressure. Other methods known to those skilled in the art can also be used to adjust the denier of the filaments in the low loft layer and the high loft layer. For example, the denier of the spunbond filaments may be reduced by splitting the conjugate fiber by using known techniques, such as those described in U.S. Pat. No. 5,759,926 to Pike et al., which is hereby incorporated by reference in its entirety.

Suitable thermoplastic polymers useful in the preparing the low loft layer include polyolefins, polyesters, polyamides, polycarbonates, polyurethanes, polyvinylchloride, polytetrafluoroethylene, polystyrene, polyethylene terephthalate, biodegradable polymers such as polylactic acid and copolymers and blends thereof. Suitable polyolefins include polyethylene, e.g., high density polyethylene, medium density polyethylene, low density polyethylene and linear low density polyethylene; polypropylene, e.g., isotactic polypropylene, syndiotactic polypropylene, blends of isotactic polypropylene and atactic polypropylene, and blends thereof; polybutylene, e.g., poly(1-butene) and poly(2-butene); polypentene, e.g., poly(1-pentene) and poly(2-pentene); poly(3-methyl-1-pentene); poly(4-methyl 1-pentene); and copolymers and blends thereof. Suitable copolymers include random and block copolymers prepared from two or more different unsaturated olefin monomers, such as ethylene/propylene and ethylene/butylene copolymers. Suitable polyamides include nylon 6, nylon 6/6, nylon 4/6, nylon 11, nylon 12, nylon 6/10, nylon 6/12, nylon 12/12, copolymers of caprolactam and alkylene oxide diamine, and the like, as well as blends and copolymers thereof. Suitable polyesters include polyethylene terephthalate, polytrimethylene terephthalate, polybutylene terephthalate, polytetramethylene terephthalate, polycyclohexylene-1,4-dimethylene terephthalate, and isophthalate copolymers thereof, as well as blends thereof.

The filaments of the low loft layer may be monocomponent filaments, meaning filaments prepared from one polymer component, multiconstituent filaments, or multicomponent filaments. The multicomponent filaments may have either of an A/B or A/B/A side-by-side cross-sectional configuration, or a sheath-core crossK-C sectional configuration, wherein one polymer component surrounds another polymer component. In the production of the low loft layer, it is desirable that multicomponent filaments are used.

In the present invention, the multicomponent filaments of the high loft layer have a filament configuration that is amenable for thermal crimping processes. For example, a conjugate filament having two component polymers (bicomponent filaments) may have a side-by-side or eccentric sheath-core cross-sectional configuration. In accordance with the present invention, the multicomponent filaments of the high loft layer contain at least two component polymers having different melting points, and the lowest melting component polymer forms at least a portion of the peripheral surface of each of the filaments. The component polymers desirably are selected to have a melting point difference between the highest melting component polymer and the lowest melting component polymer of at least about 5° C., more desirably at least about 10° C., most desirably at least about 30° C., such that the lowest melting polymer can be melted or rendered tacky without melting the higher melting component polymers of the filaments. The difference in melting point is advantageously used to bond nonwoven webs containing the multicomponent filaments. When a nonwoven web containing the conjugate filaments is heated to a temperature equal to or higher than the melting

point of the lowest melting component polymer but below the melting point of the highest melting component polymer, the melted peripheral portions of the filaments form interfiber bonds, especially at the cross-over contact points, throughout the web while the high melting polymer portions of the filaments maintain the physical and dimensional integrity of the web.

The multicomponent filaments of the high loft layer are produced from a wide variety of thermoplastic polymers that are known to form filaments, including those polymers discussed above usable for the low loft layer. As indicated above, the conjugate filaments contain at least two component polymers having different melting points. Particularly suitable polymers include polyolefins. Examples of suitable polyolefins include polyethylene, e.g., high density polyethylene, low density polyethylene and linear low density polyethylene; polypropylene, e.g., isotactic polypropylene, syndiotactic polypropylene, and blends of isotactic polypropylene and atactic polypropylene; polybutene, e.g., poly(1-butene) and poly(2-butene); polypentene, e.g., poly(1-pentene), poly(2-pentene), poly(3-mehtyl-1-pentene) and poly(4-methyl-1-pentene); copolymers thereof, e.g., ethylene-propylene copolymers; and blends thereof. Polymers suitable for the other component polymers of the conjugate filaments include above-illustrated polyolefins; polyamides, e.g., nylon 6, nylon 6/6, nylon 10, nylon 12 and the like; polyesters, e.g., polyethylene terephthalate, polybutylene terephthalate and the like; polycarbonates; polystyrenes; thermoplastic elastomers, e.g., ethylene-propylene rubbers, styrenic block copolymers, copolyester elastomers and polyamide elastomers and the like; fluoropolymers, e.g., polytetrafluoroethylene and polytrifluorochloroethylene; vinyl polymers, e.g., polyvinyl chloride; polyurethanes; and blends and copolymers thereof.

In accordance with the present invention, particularly suitable multicomponent filaments are bicomponent filaments and are polyolefin-polyolefin, e.g., polyethylene-polypropylene and polyethylene-polybutylene. Of these pairs, more particularly desirable are polyolefin-polyolefin pairs, e.g., linear low density polyethylene-isotactic polypropylene, high density polyethylene-isotactic polypropylene and ethylene-propylene copolymer-isotactic polypropylene.

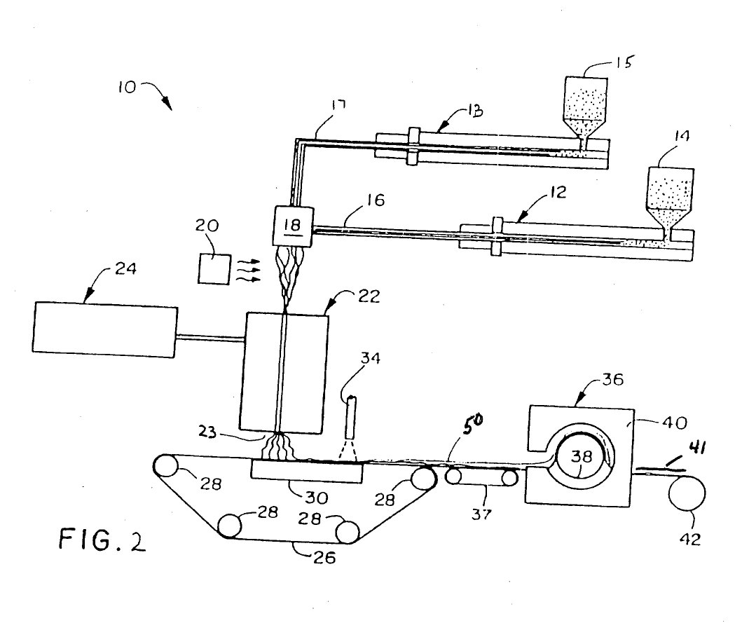

The high loft spunbond nonwoven web may be prepared by a process in which the latent crimp is activated after web formation but before bonding of the nonwoven web. To obtain a better understanding of this process, attention is directed to FIG. 2, which shows a schematic diagram illustrating methods and apparatus of this invention for producing high loft, low density materials. The process, as shown, produces crimpable bicomponent side-by-side substantially continuous filaments or eccentric sheath/core continuous filaments and causing them to crimp in an unrestrained environment.

Turning to FIG. 2, a process line 10 for preparing post formation crimp activated high loft material of the present invention is disclosed. The process line 10 is arranged to produce bicomponent continuous filaments, but it should be understood that the present invention comprehends nonwoven fabrics made with multicomponent filaments having more than two components. For example, the fabric of the present invention can be made with filaments having three, four or more components. The filaments may have an eccentric sheath/core or a side-by-side configuration. Generally, in order to obtain crimped filaments, the configuration of the filaments should be side-by-side or an eccentric sheath/core arrangement. It is noted; however, that the sheath component should have a lower melting point than the core component for filaments in a sheath/core configuration.

The process line 10 includes a pair of extruders 12 and 13 for separately extruding polymer component A and polymer component B. For the purposes of this description, it is assumed that polymer component A has a higher melting point than polymer component B. Polymer component A is fed into the respective extruder 12 from a first hopper 14 and polymer component B is fed into the respective extruder 13 from a second hopper 15. Polymer components A and B are fed from the extruders 12 and 13 through respective polymer conduits 16 and 17 to a spinneret 18. Spinnerets for extruding bicomponent filaments are well-known to those of ordinary skill in the art and thus are not described here in detail.

Generally described, the spinneret 18 includes a housing containing a spin pack which includes a plurality of plates stacked one on top of the other with a pattern of

openings arranged to create flow paths for directing polymer components A and B separately through the spinneret. The spinneret 18 has openings arranged in one or more rows. The spinneret openings form a downwardly extending curtain of filaments when the polymers are extruded through the spinneret. For the purposes of the present invention, spinneret 18 may be arranged, for example, to form side-by-side or sheath/core bicomponent filaments.

The process line 10 also includes a quench blower 20 positioned adjacent the curtain of filaments extending from the spinneret 18. Air from the quench air blower 20 quenches the filaments extending from the spinneret 18. The quench air can be directed from one side of the filament curtain as shown in FIG. 2, or both sides of the filament curtain.

A fiber draw unit (“FDU”) or aspirator 22 is positioned below the spinneret 18 and receives the quenched filaments. Fiber draw units or aspirators for use in melt spinning polymers are well-known as discussed above. Suitable fiber draw units for use in the process of the present invention include a linear fiber aspirator of the type shown in U.S. Pat. No. 3,802,817 and eductive guns of the type shown in U.S. Pat. Nos. 3,692,618 and 3,423,266, which are hereby incorporated herein by reference in their entirety. Generally described, the fiber draw unit 22 includes an elongate vertical passage through which the filaments are drawn by aspirating air entering from the sides of the passage and flowing downwardly through the passage. A blower 24 supplies aspirating air to the fiber draw unit 22. The aspirating air draws the filaments and air above the fiber draw unit through the fiber draw unit. The aspirating air in the formation of the post formation crimped filaments is unheated and is at or about ambient temperature. The ambient temperature may vary depending on the conditions surrounding the apparatus used in the process of FIG. 2. Generally, the ambient air is in the range of about 65° F. (18.3° C.) to about 85° F. (29.4° C.); however, the temperature may be slightly above or below this range, depending on the conditions of the ambient air around the fiber draw unit.

An endless forming surface 26 is positioned below the fiber draw unit 22 and receives the continuous filaments from the outlet opening 23 of the fiber draw unit. The forming surface 26 is a belt and travels around guide rollers 28. A vacuum 30 positioned below the forming surface 26 where the filaments are deposited draws the filaments against the forming surface. Although the forming surface 26 is shown as a belt in FIG. 2, it should be understood that the forming surface can also be in other forms such as a drum.

The filaments of the nonwoven web are then optionally heat treated by traversal under one of a hot air knife (HAK) or hot air diffuser 34. Generally, it is preferred that the filaments of the nonwoven web are heat treated. A conventional hot air knife includes a mandrel with a slot that blows a jet of hot air onto the nonwoven web surface. Such hot air knives are taught, for example, by U.S. Pat. No. 5,707,468 to Arnold, et al. A hot air diffuser is an alternative to the HAK which operates in a similar manner but with lower air velocity over a greater surface area and thus uses correspondingly lower air temperatures. Depending on the conditions of the hot air diffuser or hot air knife (temperature and air flow rate) the filaments may receive an external skin melting or a small degree of bonding during this traversal through the first heating zone. This bonding is usually only sufficient only to hold the filaments in place during further processing; but light enough so as to not hold the fibers together when they need to be manipulated manually. Such bonding may be incidental or eliminated altogether, if desired. The heat treatment also serves to activate the latent crimp in the filaments.

The filaments are then passed out of the first heating zone of the hot air knife or hot air diffuser 34 to a second wire 37 where the fibers continue to cool and where the below wire vacuum 30 is discontinued so as to not disrupt crimping. As the filaments cool, they will crimp in the z-direction, or out of the plane of the web, and form a high loft, low density nonwoven web.

The process line 10 further includes one or more bonding devices such as the through-air bonder 36. Through-air bonders are well-known to those skilled in the art and are not discussed here in detail. Generally described, a through-air bonder 36 includes a perforated roller 38, which receives the web, and a hood 40 surrounding the perforated roller. A conveyor 37 transfers the web from the forming surface to the through-air bonder. Lastly, the process line 10 includes a winding roll 42 for taking up the finished fabric, although the finished fabric may be directed to another operation without winding, if desired.

It should be understood; however, that other through-air bonding arrangements are suitable to practice the present invention. For example, when the forming surface is a belt, the forming surface may be routed directly through the through-air bonder. Alternatively, when the forming surface is a drum, the through-air bonder can be incorporated into the same drum so that the web is formed and bonded on the same drum. Other bonding means such as, for example, oven bonding, or infrared bonding processes which effects interfiber bonds without applying significant compacting pressure may be used in place of the through air bonder.

To operate the process line 10, the hoppers 14 and 15 are filled with the respective polymer components A and B. Polymer components A and B are melted and extruded by the respective extruders 12 and 13 through polymer conduits 16 and 17 and the spinneret 18. Although the temperatures of the molten polymers vary depending on the polymers used, when polypropylene and polyethylene are used as component A and component B respectively, the preferred temperatures of the polymers range from about 370° F. (187° C.) to about 530° F. (276° C.) and preferably range from 400° F. (204° C.) to about 450° F. (232° C.).

As the extruded filaments extend below the spinneret 18, a stream of air from the quench blower 20 at least partially quenches the filaments to develop a latent crimp in the filaments. The quench air preferably flows in a direction substantially perpendicular to the length of the filaments at a temperature of about 45° F. (7° C.) to about 90° F. (32° C.) and a velocity from about 100 to about 400 feet per minute (about 30.5 to about 122 meters per minute). The filaments must be quenched sufficiently before being collected on the forming surface 26 so that the filaments can be arranged by the forced air passing through the filaments and forming surface. Quenching the filaments reduces the tackiness of the filaments so that the filaments do not adhere to one another too tightly before being bonded and can be moved or arranged on the forming surface during collection of the filaments on the forming surface and formation of the web.

After quenching, the filaments are drawn into the vertical passage of the fiber draw unit 22 by a flow of ambient air from the blower 24 through the fiber draw unit. The fiber draw unit is preferably positioned 30 to 60 inches (0.76 to 1.5 meters) below the bottom of the spinneret 18. The filaments are deposited through the outlet opening 23 of the fiber draw unit 22 onto the traveling forming surface 26, and as the filaments are contacting the forming surface, the vacuum 20 draws the filaments against the forming surface to form an unbonded, nonwoven web of continuous filaments.

As discussed above, because the filaments are quenched, the filaments are not too tacky and the vacuum can move or arrange the filaments on the forming surface as the filaments are being collected on the forming surface and formed into the web. If the filaments are too tacky, the filaments stick to one another and cannot be arranged on the surface during formation of the web.

After the filaments are collected on the forming surface 26, the filaments are optionally heat treated with using a hot air knife or a hot air diffuser 34. The heat treatment serves one of two functions. First, the heat treatment serves to activate the latent crimp. Second, the heat treatment may serve as a preliminary bonding for the nonwoven web so that the web can be mechanical handled through the forming apparatus without damage.

When the spunbond filaments are crimped, the fabric of the present invention characteristically has a relatively high loft and is relatively resilient. The crimp of the filaments creates an open web structure with substantial void portions between filaments and the filaments are bonded at points of contact of the filaments. The temperature required to activate the latent crimp of most bicomponent filaments ranges from about 110° F. (43.3° C.) to a maximum temperature at or about melting point of polymer component B. The temperature of the air from the hot air knife or hot air diffuser can be varied to achieve different levels of crimp. Generally, a higher air temperature produces a higher number of crimps. The ability to control the degree of crimp of the filaments is particularly advantageous because it allows one to change the resulting density, pore size distribution and drape of the fabric by simply adjusting the temperature of the heat treatment.

When preliminary bonding is desired or needed, a hot air knife 34 or hot air diffuser is used and directs a flow of air having a temperature above the melting temperature of the lowest temperature melting component of the multicomponent filaments, which is the sheath component in a sheath core configuration, through the web and forming surface 26. Preferably, the hot air contacts the web across the entire width of the web. The hot air melts the lower melting point component and thereby forms bonds between the bicomponent filaments to integrate the web. For example, when polypropylene and polyethylene are used as polymer components, polyethylene should be the sheath component if the filaments are in a sheath/core multicomponent filament, the air flowing from the hot air knife or hot air diffuser preferably has a temperature at the web surface ranging from about 230° F. (110° C.) to about 500° F. (260° C.) and a velocity at the web surface from about 1000 to about 5000 feet per minute (about 305 to about 1524 meters per minute). It is noted; however, the temperature and velocity of the air from the hot air knife 34 may vary depending on factors such as the polymers which form the filaments, the thickness of the web, the area of web surface contacted by the air flow, and the line speed of the forming surface. It is noted that the if temperature of the air flowing from the hot air knife or the hot air diffuser is too hot, crimping of the filaments may not occur. Furthermore, the filaments may be heated by methods other than heated air such as exposing the filaments to electromagnetic energy such as microwaves or infrared radiation. In preparing the high loft material from polyethylene and polypropylene as the components of the bicomponent filaments, the hot air knife is operated at a temperature from about 200° F. (93° C.) to about 310° F. (154° C.) and a pressure of about 0.01 to about 1.5 inches (0.25-38.1 mm) of water. In addition, the HAK for the high loft layer is generally set about 3 to about 8 inches (76.2-203 mm) above the forming wire.

After the heat treatment of the filaments, the nonwoven web of filaments is then passed from the heat treatment zone of the hot air knife or hot air diffuser 34 to a second wire 37 where the fibers continue to cool and where the below wire vacuum 30 is discontinued. As the filaments cool and are removed from the vacuum, the filaments will crimp in the z-direction, or out of the plane of the web, thereby forming a high loft, low density nonwoven web 50.

After being optionally heat treated, the nonwoven web 50 is transferred from the forming surface 26 to the through-air bonder 36 with a conveyor 37 for more thorough bonding which will set, or fix, the web at a desired degree of loft and density achieved by the crimping of the filaments. In the through-air bonder 36, air having a temperature above the melting temperature of lower melting point component is directed from the hood 40, through the web, and into the perforated roller 38. As with the hot air knife 34, the hot air in the through-air bonder 36 melts the lower melting point component and thereby forms bonds between the bicomponent filaments to integrate the web. When polypropylene and polyethylene are used as polymer components A and B respectively, the air flowing through the through-air bonder preferably has a temperature ranging from about 230° F. (110° C.) to about 280° F. (138° C.) and a velocity from about 100 to about 500 feet per minute (about 30.5 to about 152.4 meters per minute). The dwell time of the web in the through-air bonder 36 is preferably less than about 6 seconds. It should be understood, however, that the parameters of the through-air bonder 36 also depend on factors such as the type of polymers used and thickness of the web. The nonwoven web after it is bonded in the through-air bonder 36 is bonded such that the filaments are somewhat fixed in their location in the nonwoven web resulting in a “fixed web” 41.

As an alternative to the heating zone using a combination of a hot air knife or a hot air diffuser with the through air bonder, the through air bonding (TAB) unit 40 can be zoned to provide a first heating zone in place of the hot air knife or hot air diffuser 34, followed by a cooling zone, which is in turn followed by a second heating zone sufficient to fix the web. The fixed web 41 can then be collected on a winding roll 42 or the like for later use. In this alternative configuration, when the web passes through a cool zone that reduces the temperature of the polymer below its crystallization temperature, the lower melting point polymer recrystallizes. In the case a bicomponent filament from polyethylene and polypropylene, since polyethylene is a semi-crystalline material, the polyethylene chains recrystallize upon cooling causing the polyethylene to shrink. This shrinkage induces a force on one side of the side-by-side or the eccentric sheath/core filaments that allows it to crimp or coil if there are no other major forces restricting the filaments from moving freely in any direction.

By using the unheated, approximately ambient FDU, in accordance with the above described process, the filaments are constructed so that they do not crimp in a tight helical fashion, which occurs for filaments processed through a normal heated FDU. Instead, the filaments more loosely and randomly crimp, thereby imparting more z-direction loft to the filaments. In addition to having a more loose and random crimp, the radius of the crimp generally tends to be larger as compared to filaments produced in a heated FDU. These properties result in a nonwoven web having a higher loft at a given basis weight, lower density at a given basis weight and more uniformity in the resulting nonwoven web when the post formation crimping process is used as compared to the activation of the crimp in the FDU.

Factors that can affect the amount and type of crimp include the dwell time of the web under the heat of the first heating zone. Other factors affecting crimp can include material properties such as fiber denier, polymer type, cross sectional shape and basis weight. Restricting the filaments with either a vacuum, blowing air, or bonding will also affect the amount of crimp and thus the loft, or bulk, desired to be achieved in the high loft, low density webs of the present invention. Therefore, as the filaments enter the cooling zone, no vacuum is applied to hold the fibers to the forming wire 26 or second wire 37. Blowing air is likewise controlled or eliminated in the cooling zone to the extent practical or desired.

According to one aspect of the present invention, the fibers may be deposited on the forming wire with a high degree of machine direction (MD) orientation as controlled by the amount of under-wire vacuum, the FDU pressure, and the forming height from the FDU to the wire surface. A high degree of MD orientation may be used to induce very high loft into the web, as further explained below. Further, dependent upon certain fiber and processing parameters, the air jet of the FDU will exhibit a natural frequency which may aid in the producing of certain morphological characteristics such as shingling effects into the loft of the web.

According to the exemplary embodiment of FIG. 2, wherein the filaments are heated by air flow from the hot air knife or the hot air diffuser and passed by the forming wire 26 to the second wire 37, several crimping mechanisms are believed to take place to aid in the lofting of the fibers, including, without being bound by theory:

the below-wire exhaust will cool the web by drawing surrounding air through it which prevents bonding but restricts formation of loft,

as the web is transferred out of the vacuum zone to the second wire, the vacuum force is removed and the unconstrained fibers are free to crimp,

mechanically, MD surface layer shrinkage of a highly MD oriented surface layer may cause the surface fibers to buckle,

mechanical shearing will be induced because the highly MD oriented surface shirring and bonds will leave subsurface fibers to continue shearing thereby creating loft by inducing shingling of the layers,

a mechanical buckling pattern may be produced at the natural frequency of the FDU jet which will cause the heated fibers to loft in the same frequency,

mechanical forces are created as fibers release from the forming wire 26 when leaving the vacuum area and then are briefly pulled back towards the vacuum unit 30, and

a triboelectric (frictional) static charge is built up on the web and causes the fibers to repel each other allowing further loft within the web.

When the low loft layer is a monocomponent spunbond material, any conventional spunbond apparatus may be used. When the low loft layer is a multicomponent spunbond nonwoven web, the low loft layer material is made using the same equipment as the high loft material, except the process parameters are different to achieve lower denier values. As is known in the art, reducing the throughput of the polymer through the spinneret, reducing the size of the orifices in the spin plate or increasing the pressure of the draw air through the fiber draw unit will reduce the denier of the filaments formed. Therefore, the low loft material can be prepared by reducing the through-put in the spinneret 18, by increasing the draw air through the FDU 22 by increasing the pressure of the draw air created by the blower or by using smaller orifices in the spin plate. As a result of the lower denier, the filaments are unable to crimp. Further, in preparing the low loft layer material, the temperature of the hot air knife or hot air diffuse 34 and the through-put of the air from the hot air knife or hot air diffuse 34 are increased to ensure melting of the lower melting point component, thereby creating bonding with the hot air knife or hot air diffuse 34. A hot air knife is preferred to a hot air diffuser, since hot air knife better concentrates the heat on the web than the hot air diffuser. In preparing the low loft material from polyethylene and polypropylene as the components of the bicomponent filaments, the hot air knife is operated at a temperature from about 240° F. (115.5° C.) to about 350° F. (135° C.) and a pressure of about 1.5 to about 5 inches (38.1-127.0 mm) of water. In addition, the HAK for the low loft layer is generally set about 0.5 inches to about 1.5 inches (12.7-38.1 mm) above the forming wire.

The low loft layer and the high loft layer may be bonded to each other using any known techniques. The layers of the laminate of the present invention can be adjoined by various means that intimately juxtapose the layers together. For example, the layers can be bonded to have uniformly distributed bond points or regions. Useful bonding means for the present invention include adhesive bonding, e.g., print bonding;

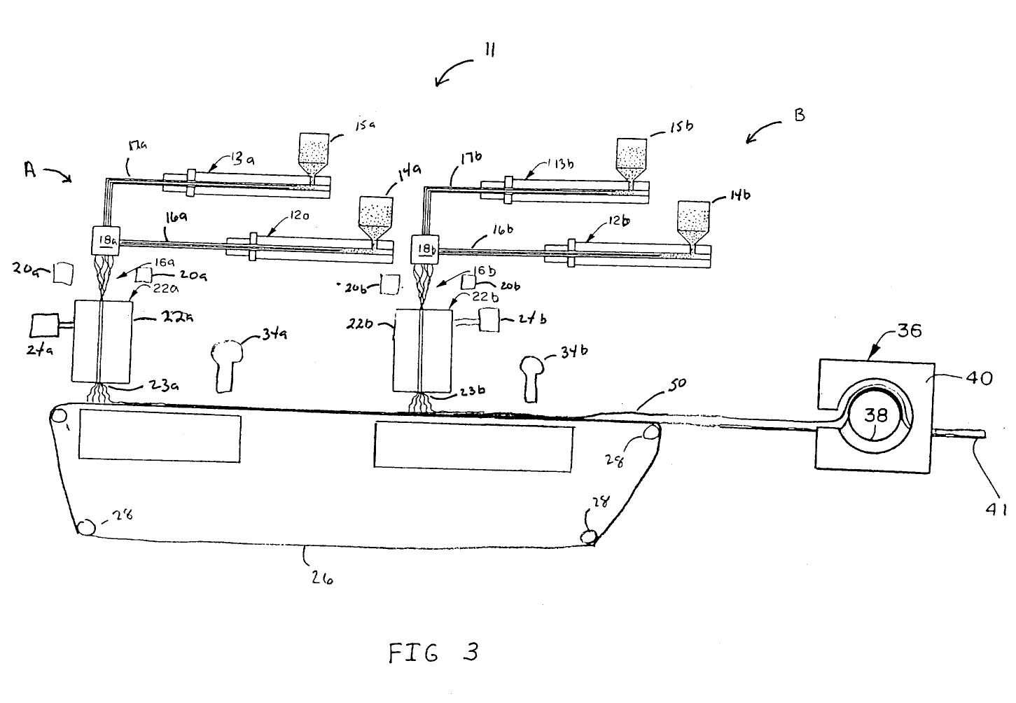

thermal bonding, e.g., point bonding; and ultrasonic bonding processes, provided that the selected bonding process does not alter, e.g., diminish, the permeability or loftiness of the web layers or the interface of the layers to a degree that makes the laminate undesirable for its intended use. Alternatively, the layers can be bonded only at the peripheral edges of the media, relying on the pressure drop across the media during use to form juxtaposed laminates. As another alternative, the layers can be sequentially formed on a forming surface. An example of this process is shown in FIG. 3.

In FIG. 3, a process line 11 for preparing a low loft/high loft laminate in-line is shown. The process line, as shown, has two fiber forming processes A and B. In operating each of the fiber forming lines A and B, each of the components operates as described above for FIG. 2, with the letter “a” designating the A fiber forming process and “b” designating the B fiber forming process. Since the operation of these process components is described above, a description of the common component will not be given here.

In process 11, the A process produces the low loft multicomponent spunbond layer. This low loft layer is formed on a forming surface 26 and is heated under a hot air knife 34a as described above. It is noted that the temperature of the hot air knife 34a should be high enough soften the lower melting point component, but not too high so that a film-like material is formed from the lower melting point component. Before the low lofted layer is bonded in a through air bonder 40, the low loft layer is conveyed under the high loft forming apparatus of the B process and the high loft multicomponent spunbond layer is formed directly on the low loft layer using the process conditions described above. The two layer structure 50 is then transferred to a bonding apparatus 36, such as a through air bonder and the low loft layer and the high loft layer are firmly bonded together since the component having the low melting point is melted in both layer, hence bonding the two layers together, resulting in the multilayer laminate 41. It is noted that the process of FIG. 3 can be further modified by adding additional fiber forming processes to form a laminate with higher loft or to form a laminate with a layer of a different nonwoven material. In addition, film forming apparatus can also be inserted in the process line of FIG. 3, if desired.

It has been discovered that the high loft material made by the process described above can be used to produce high loft, low density layer of the nonwoven web having a density as low as 1 kg/m³ and a bulk up to about 50 mm or more. If additional bulk is needed or desired, two or more of the high loft materials may be laminated together. The ratio of the high loft layer to the low loft layer in the present invention on a weight basis is about 85:15 to about 15:85. Desirably, the ratio is about 70:30 to about 30:70 and more desirably about 60:40 to 60:40.

In another aspect of the present invention, a third layer, which is a low loft, high density layer may be placed on the side of the high loft, low density layer which is opposite the first layer. As with the first layer, the third layer would also have a higher density that the first layer and the fibers of the third layer would also be a spunbond layer having filaments with a denier less than 1.8 dpf (2.0 dtex) and the density of the third layer would be greater than the density of the high loft, low density layer. Further, an additional high loft, low density layer may be adjacent to the third layer, opposite the second layer. As with the second layer, this fourth layer would contain filaments having a denier greater about 2.3 dpf (2.55 dtex). Further, the density of the fourth layer would be less than the density of the first and third layers.

Pressure drop is a measure of the force required to get a volume of air through a sheet. The laminate of the high loft material and the low loft material of the present invention preferably has a pressure drop at least about 1 mm water at a flow rate of about 32 liters/minute (“L/min.”). More preferably, the pressure drop should be about 3 mm to about 12 mm water at a flow rate of about 32 L/min. The pressure drop is measured using ASTM F 779-88 test method.

The Frazier permeability of the laminate of the high loft material and the low loft material of the present invention is between about 10 cubic feet per minute per square foot (cfm/ft²) (about 4.87 cubic meters per minute per square meter (m³/min./m²) and about 150 cubic feet per minute per square foot (cfm/ft²) (about 45.69 cubic meters per minute per square meter (m³/min./m²). Ideally, the Frazier permeability should be between about 15 cfm/ft² and about 30 cfm/ft². The Frazier permeability was tested using a Frazier Air Permeability tester available from Frazier Precision Instrument Company and measure in accordance with Federal Test Method 5450, Standard No. 191A (ASTM 737-96).

The laminate of the high loft material and the low loft material can be used in a wide variety of end uses. The uses include, but are not limited to, acoustical insulation, thermal insulation, a filter media, a surge layer in a personal care product such as a diaper, a wipe, a mop and the like.

The filaments making up the high loft layer and the low loft layer may independently be round fibers, shaped fibers, such has multilobal fibers. In the practice of the present invention; however, it is generally desirable to use round fibers, but not required to be round fibers.

In using the laminate of the present invention as an acoustical insulation material, the laminate is placed between a sound source area and a sound receiving area called the “second area”. The laminate attenuates the sound coming from the source area by absorbing the sound and/or by reflecting such sound waves outwardly and away from a receiving area.

The acoustical insulation performance of the laminate described above can be further improved by adding at least one meltblown layer to the laminate. Desirably, the meltblown layer has a density greater than about 50 kg/m³ and is formed from thermoplastic meltblown fibers having an average fiber diameter of less than about 7 microns.

Meltblown nonwoven webs are known in the art and have been used in a wide variety of applications, including acoustical insulation. The meltblown layer of the laminate of the present invention is characterized in that it contains relatively closely distributed meltblown fibers that are randomly dispersed and autogenously bonded. These properties are responsible for a relatively high pressure drop and low permeability, which improves the sound attenuating properties of the laminate. The meltblown layer is very effective in improving the overall sound absorption properties of the laminate.

The thermoplastic meltblown fibers have an average fiber diameter of less than about 7 microns. Desirably, the thermoplastic meltblown fibers have a fiber diameter less than about 5 microns and more desirably between about 1.0 micron to about 4.0 microns. If the average fiber diameter is greater than about 7 microns, the permeability of the acoustical insulation tends to be increased and the pressure drop of the acoustical insulation tends to be decreased, which corresponds to a decrease in the sound attenuating properties.

The meltblown nonwoven web layer of the present invention has a density greater than about 50 kg/m³. The upper limit of the density is not critical to the present invention. However, from a practical standpoint of producing the meltblown, the upper limit for the density is about 250 kg/m³. Ideally, the density for the meltblown nonwoven web is between about 55 kg/m³ and about 150 kg/m³ and desirably about 58 kg/m³ to about 100 kg/m³.

Surprisingly, it has been discovered that meltblown nonwoven webs having a thickness less than 3 mm improve the sound attenuating properties of the laminate of the high loft layer and the low loft layer described above. As is noted in the Background of the Invention, it has been generally preferred in the sound attenuation art that the meltblown acoustical insulation has a thickness greater than about 3 mm. It has been discovered that meltblown nonwoven webs having a thickness as low as about 0.2 mm can further improve the sound attenuating properties of the two layer laminate described above, provided that the meltblown fibers have a fiber diameter less than about 7 microns and the density of the nonwoven web is at least 50 kg/m³. From a standpoint of cost and ability to prepare the high density and low loft meltblown nonwoven, a thickness of up to about 3 mm is practical to produce. Higher thickness could be produced; however the cost of production would dramatically rise. It is preferred that the thickness of the meltblown nonwoven web sound attenuating material of the present invention has a thickness of about 0.2 mm to about 2.5 mm, more preferably between about 0.3 mm and 1.0 mm. The thickness of the acoustical insulation material is measured at 0.05 psi (3.5 g/cm³) with a STARRET-7 type bulk tester. Samples were cut into 4 inch by 4 inch (10.2 cm by 10.2 cm) squares and five samples were tested to determine bulk or thickness.

The meltblown fibers are preferably prepared from thermoplastic polymers. The thermoplastic polymers described above for the spunbond layers are also suitable for the meltblown fibers of the meltblown layer.

The meltblown fibers may be monocomponent fibers, meaning fibers prepared from one polymer component, multiconstituent fibers, or multicomponent fibers. The multicomponent fibers may have either of an A/B or A/B/A side-by-side configuration, a pie configuration or a sheath-core configuration, wherein one polymer component surrounds another polymer component. Any of the above described thermoplastic polymers may be used as each component of the multicomponent fibers. Selection of the thermoplastic polymers of multicomponent fibers can change the properties of the resulting fibers. For example, if the thermoplastic components are incompatible with one another, the bicomponent fibers may be split to form finer fibers with a stimulus, such as heat or high pressure water. Examples of possible splitting methods are described in detail in U.S. Pat. No. 5,759,926 to Pike et al., which is hereby incorporated by reference in its entirety. If the melting points of the individual thermoplastic polymers are different from one other, it is possible to crimp the fibers by applying heat to activate the crimp. In forming the bicomponent fibers which can be used as the meltblown fibers of the present invention, it is desirable to produce fibers which are splittable, to drive down the average fiber diameter of the fibers upon splitting. If split fibers are not desired, it is generally preferred to use side-by-side fibers from similar polymers, such as polyolefins. A preferred multicomponent fiber configuration is a side-by-side multicomponent fiber where at least one component contains polyethylene and at least one component contains polypropylene.

The meltblown nonwoven web used in the laminate can be made by any process known in the art. An exemplary process is disclosed in U.S. Pat. No. 3,849,241 to Butin et al., where air-borne fibers, which are not fully quenched, are carried by a high velocity gas stream and deposited on a collecting surface to form a web of randomly dispersed and autogenously bonded meltblown fibers. As is known in the art, the flow rate, temperature and pressure of the high velocity gas stream can be adjusted to form continuous meltblown fibers or discontinuous fibers, as well as, they can be adjusted to change the average fiber diameter and other properties of the fibers. The meltblown nonwoven web may be formed using a single meltblown die or a series of meltblown dies.

The physical attributes, such as abrasion resistance or tear strength, of the acoustical insulation can be improved by pattern bonding the meltblown nonwoven, or other process such as meltblowing a layer of meltblown fibers having an average fiber diameter greater than about 10 microns. Pattern bonding can be accomplished by thermal bonding or ultrasonic bonding.

Alternatively, the surface of the meltblown nonwoven web can be made abrasive and/or abrasion resistant by meltblowing a relatively light layer of coarse meltblown fibers onto the surface of the meltblown nonwoven web. This may be accomplished by adding a second meltblown die in line with the meltblown die producing the meltblown nonwoven web or by rolling the nonwoven web of the fine fibers and unrolling the fine fiber meltblown and meltblowing the coarse meltblown fibers onto the fine fiber meltblown, such as the process shown in U.S. Pat. No. 4,659,609 to Lamers et al, which is hereby incorporated by reference. In the practice of this invention, the average fiber diameter of the coarse meltblown fibers are at least about 10 microns, and preferably between about 15 microns and about 39 microns.

As is known in the art, the characteristics of the meltblown fibers can be adjusted by manipulation of the various process parameters used for each extruder and die head in carrying out the meltblowing process. The following parameters can be adjusted and varied for each extruder and die head in order to change the characteristics of the resulting meltblown fibers:

1. Type of Polymer,

2. Polymer throughput (pounds per inch of die width per hour—PIH),

3. Polymer melt temperature,

4. Air temperature,

5. Air flow (standard cubic feet per minute, SCFM, calibrated the width of the die head),

6. Distance from between die tip and forming belt and

7. Vacuum under forming belt.

An additional advantage of using fine fiber meltblown in the laminate when the laminate is used as an acoustical insulation is that the fine fiber meltblown also act as a moisture barrier, preventing moisture from passing through the insulation material. Even though that the acoustical insulation has these moisture barrier properties, the material still allows for air to pass through the structure.

The meltblown layer may be placed next to the low loft layer and opposite the high loft layer creating a laminate structure with the low loft material between the meltblown layer and the high loft layer, next to the high loft layer and opposite the low loft layer, or between the high loft layer and the low loft layer creating a laminate structure with the high loft material between the meltblown layer and the low loft layer. Attention is directed to FIG. 1B which shows a laminate 111 with the meltblown layer 115 adjacent to the low loft layer 110 and opposite the high loft layer 120. FIG. 1C shows a laminate 111 with the meltblown layer 115 adjacent to the high loft layer 120 and opposite the low loft layer 110. FIG. 1D shows the meltblown layer 115 between the high loft layer 120 and the low loft layer 110. Desirably, the meltblown layer is placed next to the low loft layer on the side opposed to the high loft layer, as shown in FIG. 1B. The desired laminate containing the meltblown layer has a structure meltblown layer/low loft layer/high loft layer.

The low loft layer, the high loft layer and the meltblown layer may be bonded to each other using any known techniques. The layers of the laminate material of the present invention can be adjoined by various means that intimately juxtapose the layers together. For example, the layers can be bonded to have uniformly distributed bond points or regions. Useful bonding means for the present invention include adhesive bonding, e.g., print bonding; thermal bonding, e.g., point bonding; and ultrasonic bonding processes, provided that the selected bonding process does not alter, e.g., diminish, the permeability or loftiness of the web layers or the interface of the layers to a degree that makes the laminate undesirable for its intended use. Alternatively, the layers can be bonded only at the peripheral edges of the media, relying on the pressure drop across the media during use to form juxtaposed laminates.

In forming the laminate including the meltblown layer, each of the layers may be formed separately, and laminated together in a laminating step. The high loft and low loft laminate material may be as shown in FIG. 3 with the meltblown nonwoven being supplied to the process at a location to place it its desired location, i.e. before the formation of the low loft layer, after the through air bonder, before the formation of the high loft material or any other suitable location. The meltblown may be supplied from a roll or formed in line with the low loft material and high loft material. It is not critical to the present invention where or how the meltblown is incorporated with the high loft layer and the low loft layer.

With the meltblown layer added the laminate structure, the laminate has a pressure drop at least about 1 mm water at a flow rate of about 32 liters/minute (“L/min.”). More preferably, the pressure drop should be about 3 mm to about 12 mm water at a flow rate of about 32 L/min. The pressure drop is measured using ASTM F 779-88 test method.

With the meltblown layer added the laminate structure, the laminate the Frazier permeability of the laminate should be less than about 75 cubic feet per minute per square foot (cfm/ft²) (about 22.9 cubic meters per minute per square meter (m³/min./m²). Ideally, the Frazier permeability should be less than about 50 cfm/ft² and preferably less than about 30 cfm/ft2. The Frazier permeability was tested using a Frazier Air Permeability tester available from Frazier Precision Instrument Company and measure in accordance with Federal Test Method 5450, Standard No. 191A(ASTM 737-96).

In the present invention, the high loft layer will generally have a thickness or loft in excess of 3 mm. The upper limit for the thickness of the high loft layer is dependent on the final use of the sound insulation material and is generally limited by the space which needs to be filled to attenuate sound. For example, in a house with 2×4 construction, the upper limit will be the thickness of the walls which would be the nominal thickness of the 2×4 of 3.5 inches (8.9 cm). From a practical standpoint, the upper limit of the thickness of the high loft layer should be usually less than about 30.5 cm. Again, the final utility of the sound insulation material will dictate the thickness of the high loft layer. At a minimum, the high loft layer fills a cavity and helps hold the first layer in place during use.

When the laminate with the meltblown layer is used as an acoustical insulation material, the laminate may be used in a wide variety of locations where sound attenuation is desired but little space is provided for a sound attenuating material. Examples of possible uses include small appliances, large appliances, vehicles such as cars, airplanes and the like, architectural applications such as in homes, commercial buildings and in HVAC systems.

In using the acoustical insulation of the present invention, with or without the meltblown layer, the laminate is placed between a sound source area and a sound receiving area called the “second area”. The laminate attenuates the sound coming from the source area by absorbing the sound and/or by reflecting such sound waves outwardly and away from a receiving area.

The acoustical insulation materials of the present invention were tested for absorption using a Model # 4206 impedance tube available from Bruel & Kjaer. The test procedures in accordance with ASTM E1050-98 were followed. The absorption coefficient was recorded and graphed. The acoustical insulation material of the present invention is effective in attenuating sound up to and beyond 6.3 kHz

### EXAMPLES

### Example 1

A laminate having a high density layer and a low density layer with an overall basis weight of about 6.0 osy (204 gsm) was prepared using the process of shown in FIG. 3. The fibers of the high density, low loft layer were polyethylene/polypropylene side-by-side fibers. The fibers were prepared by extruding about 0.7 grams per hole/min of the total polymer and the resulting fibers were quenched with air at 60° F. (15.5° C.). The high density low loft layer had the fibers drawn at a FDU pressure of 6 psi and the HAK was set at 1 in (2.54 cm) above the formed web and had a temperature of 270° F. (132° C.). The high density, low loft layer had a basis weight of about 3.6 osy (122 gsm) and an average fiber denier of about 1.43 dpf and a thickness of 2.6 mm.

Onto the high density, low loft layer, a low density, high loft layer is formed from polyethylene/polypropylene side-by-side fibers which were prepared by extruding about 0.5 grams per hole/min of the total polymer and were quenched with air at 60° F. (15.5° C.). The low density high loft layer had the fibers drawn at a FDU pressure of 4.5 psi and the HAK was set at 5 in (12.7 cm) above the formed web and had a temperature of 235° F. (112° C.). The low density high loft layer had a basis weight of about 2.4 osy (82 gsm) and an average fiber denier of about 2.65 dpf. and a thickness of 8.1 mm.

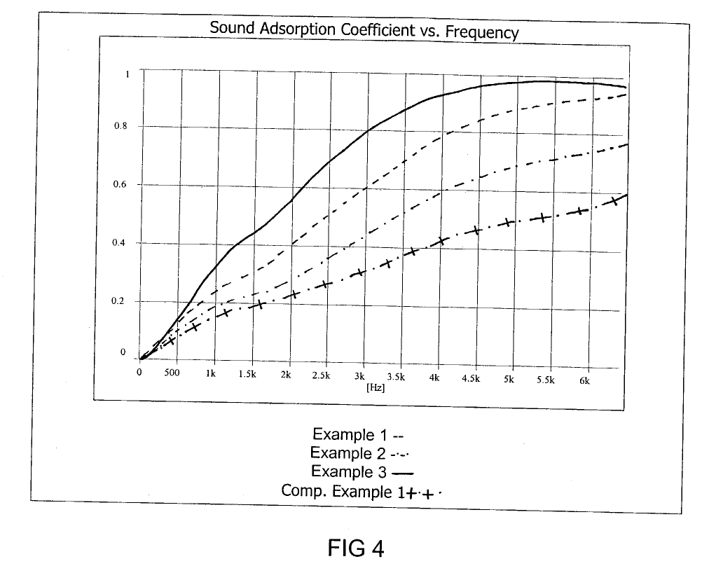

The laminate was run through a through air bonder having a air velocity of 100 ft/min (30.5 m/min) at a temperature of 265° F. (129° C.) and then cooled with ambient air. The laminate had an overall bulk of 10.7 mm. The material was tested for sound absorption using a Model # 4206 impedance tube available from Bruel & Kjaer. The test procedures in accordance with ASTM El 050-98 were followed. The absorption coefficient was recorded and graphed, the results being shown as FIG. 4. The acoustical insulation material of the present invention is effective in attenuating sound up to and beyond 6.3 kHz.

### Example 2

A laminate having an overall basis weight of about 6.0 osy (204 gsm) was prepared using the process of shown in FIG. 3. The fibers of the high density, low loft layer were polyethylene/polypropylene side-by-side fibers. The fibers were prepared by extruding about 0.5 grams per hole/min of the total polymer and the resulting fibers were quenched with air at 60° F. (15.5° C.). The high density low loft layer had the fibers drawn at a FDU pressure of 6 psi and the HAK was set at 1 in (2.54 cm) above the formed web and had a temperature of 270° F. (132° C.). The high density, low loft layer had a basis weight of about 2.4 osy (82 gsm) and an average fiber denier of about 1.8 dpf and a thickness of 3.1 mm.

Onto the high density, low loft layer, a low density, high loft layer is formed from polyethylene/polypropylene side-by-side fibers which were prepared by extruding about 0.7 grams per hole/min of the total polymer and were quenched with air at 60° F. (15.5° C.). The low density high loft layer had the fibers drawn at a FDU pressure of 4.5 psi and the HAK was set at 5 in (12.7 cm) above the formed web and had a temperature of 235° F. (112° C.). The low density high loft layer had a basis weight of about 3.6 osy (122 gsm) and an average fiber denier of about 3.2 dpf and a thickness of 4.8 mm.

The laminate was run through a through air bonder having a air velocity of 100 f/min (30.5 m/min) at a temperature of 265° F. (129° C.) and then cooled with ambient air. The laminate had an overall bulk of 7.9 mm. The material was tested for sound absorption using a Model # 4206 impedance tube available from Bruel & Kjaer. The test procedures in accordance with ASTM E1050-98 were followed. The absorption coefficient was recorded and graphed, the results being shown as FIG. 4.

### Example 3

A laminate was prepared by laminating two laminates prepared in accordance with Example 1 forming a four-layer laminate. The material was tested for sound absorption using a Model # 4206 impedance tube available from Bruel & Kjaer. The test procedures in accordance with ASTM El 050-98 were followed. The absorption coefficient was recorded and graphed, the results being shown as FIG. 4. The acoustical insulation material of the present invention is effective in attenuating sound up to and beyond 6.3 kHz.

### Comparative Example 1

A fiberglass insulation material having a bulk of 12.7 mm, and a basis weight of 228 gsm was also tested for sound absorption using a Model # 4206 impedance tube available from Bruel & Kjaer, in accordance with ASTM El 050-98. The absorption coefficient was recorded and graphed, the results being shown as FIG. 4.

As can be seen in from FIG. 4, the laminate of the present invention has better sound absorbing properties as compared to a conventional sound insulating material.

### Examples 4-6

Laminates of a high density, low loft layer, a low density, high loft layer and a meltblown layer were prepared. Each of the high loft layer and the low loft layer were prepared in accordance with Example 1 above. The meltblown layer has a thickness of 0.064 cm, a density of about 94 kg/m³, and the fibers have an average diameter of about 3 microns, available from Kimberly-Clark Corporation, Roswell, Ga.

The meltblown layer was placed adjacent the high density, low loft layer (Example 4), between the high density, low loft layer and the low density, high loft layer (Example 5) or adjacent to the low density, high loft layer (Example 6). In the case of Example 4, the Example 1 is modified to supply the meltblown nonwoven layer after the formation of the low loft layer but before formation of the high loft layer.

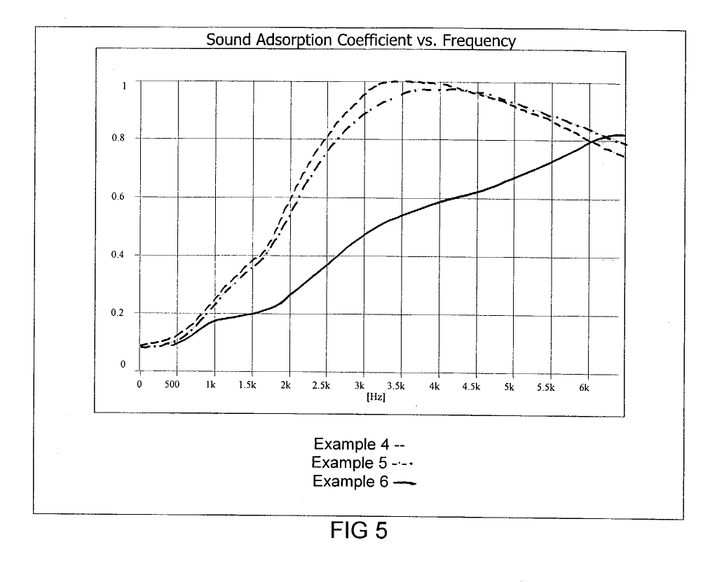

Each material was tested for sound absorption using a Model # 4206 impedance tube available from Bruel & Kjaer. The test procedures in accordance with ASTM E1050-98 were followed. The absorption coefficient was recorded and graphed, the results being shown as FIG. 5.

Comparing FIG. 4 to FIG. 5, it can be seen that the addition of the meltblown layer improves the overall sound absorption performance of the laminate at lower less than 4 kHz, when the meltblown layer is between the high loft layer and the low loft layer, or is adjacent to the high density, low loft layer.

While the invention has been described in detail with respect to specific embodiments thereof, and particularly by the example described herein, it will be apparent to those skilled in the art that various alterations, modifications and other changes may be made without departing from the spirit and scope of the present invention. It is therefore intended that all such modifications, alterations and other changes be encompassed by the claims.

We claim:

1. A nonwoven laminate comprising
a first layer comprising thermoplastic spunbond filaments having an average denier less than about 1.8 dpf; and
a second layer comprising thermoplastic multicomponent spunbond filaments having an average denier greater than about 2.3 dpf;
wherein the density of the first layer is greater than the density of the second layer and the thickness of the second layer is greater than the thickness of the first layer.

2. The nonwoven laminate of claim 1, wherein the spunbond filaments of the first layer comprise multicomponent spunbond filaments.

3. The nonwoven laminate of claim 2, wherein the spunbond filaments of the first layer have an average denier less than about 1.7 dpf.

4. The nonwoven laminate of claim 3, wherein the spunbond filaments of the first layer have an average denier less than about 1.5 dpf.

5. The nonwoven laminate of claim 1, wherein the multicomponent spunbond filaments of the second layer have an average denier greater than about 3.0 dpf.

6. The nonwoven laminate of claim 5, wherein the multicomponent spunbond filaments of the second layer have an average denier greater than about 4.0 dpf.

7. The nonwonen laminate of claim 1, wherein the density of the first layer is greater than about 40 kg/m³.

8. The nonwoven laminate of claim 1, wherein the density of the second layer is less than about 50 kg/m³.

9. The nonwoven laminate of claim 1, wherein the density of the first layer is greater than about 50 kg/m³ and the density of the second layer is less than about 40 kg/m³.

10. The nonwoven laminate of claim 2, wherein the density of the first layer is greater than about 50 kg/m³, the density of the second layer is less than about 30 kg/m³; the multicomponent spunbond filaments of the first layer have an average denier less than about 1.5 dpf and the multicomponent spunbond filaments of the second layer have an average denier greater than about 3.0 dpf.

11. The nonwoven laminate of claim 2, wherein the multicomponent filaments of the first layer and the second layer comprise filaments having a side-by-side configuration.

12. The nonwoven laminate of claim 10, wherein the multicomponent filaments of the first layer and the second layer comprise filaments having a side-by-side configuration.

13. The nonwoven laminate of claim 2, wherein the multicomponent filaments comprise a thermoplastic polymer selected from the group consisting of polyolefins, polyesters, polyamides, polycarbonates, polyurethanes, polyvinylchloride, polytetrafluoroethylene, polystyrene, polyethylene terephathalate, polylactic acid and copolymers and blends thereof.

14. The nonwoven laminate of claim 13, wherein the thermoplastic polymers of the multicomponent filaments comprise polyolefins.

15. The nonwoven laminate of claim 14, wherein at least one component of the multicomponent filaments comprises polyethylene and at least one other component comprises polypropylene.

16. The nonwoven laminate of claim 15, wherein the density of the first layer is greater than about 50 kg/m³, the density of the second layer is less than about 30 kg/m³; the multicomponent spunbond filaments of the first layer have an average denier less than about 1.5 dpf and the multicomponent spunbond filaments of the second layer have an average denier greater than about 3.0 dpf.

17. The nonwoven laminate of claim 1, further comprising a third layer, the third layer comprising a nonwoven web having a density of at least 50 kg/m³ and comprising thermoplastic meltblown filaments having an average fiber diameter of less than about 7 microns

18. The nonwoven laminate of claim 2, further comprising a third layer, the third layer comprising a nonwoven web having a density of at least 50 kg/m³ and comprising thermoplastic meltblown filaments having an average fiber diameter of less than about 7 microns.

19. The nonwoven laminate of claim 18, wherein the third layer has a thickness less than about 3 mm.

20. The nonwoven laminate of claim 19, wherein the thermoplastic filaments of the third layer have an average fiber diameter of less than about 5 microns.

21. The nonwoven laminate of claim 20, wherein the thermoplastic filaments of the third layer have an average fiber diameter of about 1.0 microns to about 4.0 microns.

22. The nonwoven laminate of claim 21, wherein the thickness of the third layer is between about 0.2 mm to about 2.5 mm and the density of the nonwoven web of the third layer is between about 55 kg/m³ and about 150 kg/m³.

23. The nonwoven laminate of claim 22, wherein the thickness of the third layer is between about 0.3 mm to about 1.0 mm and the density of the nonwoven web of the third layer is between about 58 kg/m³ and about 100 kg/m³.

24. The nonwoven laminate of claim 17, wherein the thermoplastic meltblown filaments of the third layer comprise a thermoplastic polymer selected from the group consisting of selected from the group consisting of polyolefins, polyesters, polyamides, polycarbonates, polyurethanes, polyvinylchloride, polytetrafluoroethylene, polystyrene, polyethylene terephathalate, polylactic acid and copolymers and blends thereof.

25. The nonwoven laminate of claim 24, wherein the thermoplastic polymer of the third layer comprises a polyolefin.

26. The nonwoven laminate of claim 1, wherein the laminate has a pressure drop of at least 1 mm of water at a flow rate of about 32 liters/min.

27. The nonwoven laminate of claim 26, wherein the pressure drop is between about 3 mm and about 10 mm of water at a flow rate of about 32 liters/min.

28. The nonwoven laminate of claim 2, wherein the multicomponent spunbond filaments of the first layer are split.

29. The nonwoven laminate of claim 18, wherein the multicomponent spunbond filaments of the first layer are split.

30. The nonwoven laminate of claim 1, further comprising a third layer, the third layer comprising thermoplastic spunbond filaments having an average denier less than about 1.8 dpf, wherein the third layer is adjacent to the second layer opposite the first layer and the density of the third layer is greater than the density of the second layer and the thickness of the second layer is greater than the thickness of the third layer.

31. The nonwoven laminate of claim 30, wherein the spunbond filaments of the third layer comprise multicomponent spunbond filaments.

32. The nonwoven laminate of claim 30, further comprising a forth layer, the fourth layer comprising thermoplastic multicomponent spunbond filaments having an average denier greater than about 2.3 dpf, wherein the fourth layer is adjacent to the second layer opposite the first layer and the density of the fourth layer is less than the density of the third layer and the thickness of the fourth layer is greater than the thickness of the third layer.

33. An acoustical insulation comprising the nonwoven laminate of claim 1.

34. An acoustical insulation comprising the nonwoven laminate of claim 17.

35. A thermal insulation comprising the nonwoven laminate of claim 1.

36. A thermal insulation comprising the nonwoven laminate of claim 17.

37. A building material comprising the nonwoven laminate of claim 1.

38. A building material comprising the nonwoven laminate of claim 17.

39. A method of attenuating sound waves passing from a sound source area to a second area comprising positioning the nonwoven laminate of claim 1 between the sound source area and the second area.

40. A method of attenuating sound waves passing from a sound source area to a second area comprising positioning the nonwoven laminate of claim 17 between the sound source area and the second area.
